(19) United States
(12) Patent Application Publication
(10) Pub. No.: US 2021/0191227 A1
(43) Pub. Date: Jun. 24, 2021

(54) DEVICE FOR DEFLECTING LASER BEAMS

(71) Applicant: Robert Bosch GmbH, Stuttgart (DE)

(72) Inventors: Jan Niklas Caspers, Stuttgart (DE); Jens Ehlermann, Böblingen (DE)

(21) Appl. No.: 16/770,937

(22) PCT Filed: Dec. 14, 2018
(86) PCT No.: PCT/EP2018/084991

§ 371 Date: Jun. 8, 2020

(30) Foreign Application Priority Data
Dec. 15, 2017 (DE) 10 2017 222 864.4

(51) Int. Cl. G02F 1/295; G01S 7/481

(52) U.S. Cl. CPC G02F 1/2955; G01S 7/4817; G01S 7/4814

(57) ABSTRACT

A device for deflecting laser beams, including at least one light source configured for generating laser beams, and at least one integrated optical circuit. The integrated optical circuit is situated on a substrate. The substrate has a first, second, and third main directions of extension. The first and second main directions of extension span a plane of the substrate surface. The third main direction of extension is orthogonal to the plane of the substrate surface. The integrated optical circuit includes at least one waveguide and at least one emission means. The emission means functions as an output of the integrated optical circuit and emits the laser beams along a first direction. A deflection means is provided, spaced apart from the substrate, along the first, second, or third main directions of extension. The deflection means deflects the laser beams along a second direction different from the first direction.

### FIELD

The present invention relates to a device for deflecting laser beams.

### BACKGROUND INFORMATION

Conventional beam deflection units based on optical phase shifters may function without moving components. Such beam deflection units are thus used as a substitute for mechanical mirrors. Deflection angles in the range of approximately 5° to 15° are typically achieved.

It is disadvantageous that the deflection angle is too small for LIDAR applications, which require much larger deflection angles.

United States Patent Application Publication No. US 2016/0049765 A1 describes a plurality of one-dimensional beam-forming chips that form a two-dimensionally scanning solid state array, so that a three-dimensional surroundings image may be detected. The solid state arrays are situated one above the other, and emit at one end of the particular chip. The control direction is situated in the chip plane.

It is disadvantageous that the deflection angles of the laser beams are determined by the orientation of the particular solid state array. In other words, the resolution in the vertical deflection dimension cannot be changed.

An object of the present invention is to change and increase the deflection angle.

### SUMMARY

In accordance with an example embodiment of the present invention, a device for deflecting laser beams includes at least one light source that is configured for generating laser beams, and at least one integrated optical circuit. The integrated optical circuit is situated on a substrate. The substrate has a first main direction of extension, a second main direction of extension, and a third main direction of extension. The first main direction of extension and the second main direction of extension span a plane of the substrate surface, and the third main direction of extension is orthogonal to the plane of the substrate surface. The integrated optical circuit includes at least one waveguide and at least one emission means (emission element), the emission means functioning as an output of the integrated optical circuit and the laser beams emitting along a first direction. According to the present invention, a deflection means (i.e., deflector element) is provided which is spaced apart from the substrate along the first main direction of extension or along the second main direction of extension or along the third main direction of extension, the deflection means deflecting the laser beams along a second direction, the second direction being different from the first direction.

The advantage is that the deflection angle is changeable independently of the orientation of the substrate.

In one refinement of the present invention, the integrated optical circuit includes at least one optical phase shifter and at least two emission means. In other words, the integrated optical circuit is designed as a phase-controlled group antenna. A phase-controlled group antenna is also known as an optical phased array antenna.

An advantage is that the light that is emitted by the at least two emission means creates an interference which may be controlled by the phase shifter. This control allows the beam to be deflected along the first direction. This means that the direction of the laser beams at the output of the emission means may be different from the direction of the laser beams at the output of the deflection device.

In one refinement of the present invention, multiple integrated optical circuits are provided that are designed as one- or two-dimensional arrays and that are situated on a shared carrier substrate. In other words, the integrated optical circuits constitute or form an area array.

It is advantageous that multiple laser beams may be simultaneously deflected, and these laser beams may cover different scanning areas, i.e., allow parallelization of the laser beams. The laser beams that are emitted by the optical circuit are deflected in various directions, depending on the position and shape of the deflection means. In other words, the deflection means does not deflect every beam in the same direction.

In another embodiment of the present invention, the first direction corresponds to the third main direction of extension.

The advantage is that beams that are emitted perpendicularly with respect to the substrate surface may be deflected.

In one refinement of the present invention, the first direction corresponds to the first main direction of extension or to the second main direction of extension.

It is advantageous that beams that are emitted in the plane of the substrate surface at one end of the substrate of the integrated optical circuits may be deflected.

In another embodiment of the present invention, multiple integrated optical circuits are situated one above the other, spaced apart along the third main direction of extension. The carrier substrates on which the integrated optical circuits are situated are in particular situated in parallel.

An advantage is that the effort for alignment between the optical circuits may be minimized, and a simple configuration for deflecting the laser beams may thus be selected.

In one refinement of the present invention, the deflection means includes at least one lens.

It is advantageous that the lens additionally deflects the optical beam that is emitted by the integrated optical circuits. The lens has the advantage in particular that this additional deflection is continuous, so that areas into which no beams can be deflected may thus be prevented from arising in the overall deflection range.

In another embodiment of the present invention, the deflection means includes a microlens array.

The advantage is that the deflection angle range for the optical circuits may be set differently and individually.

In one refinement of the present invention, the deflection means includes a multistage prism.

It is advantageous that different deflection angles may be achieved.

Further advantages result from the description below of exemplary embodiments of the present invention and from the figures.

### BRIEF DESCRIPTION OF EXAMPLE EMBODIMENTS

The present invention is explained below with reference to preferred specific embodiments and the figures.

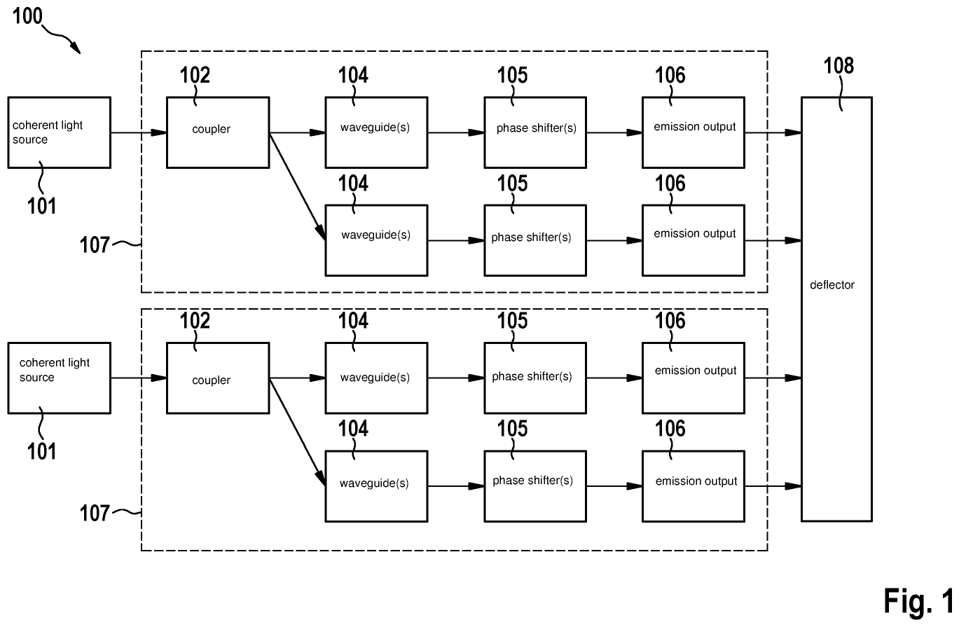

FIG. 1 shows a schematic layout of an example device for deflecting laser beams in accordance with an example embodiment of the present invention.

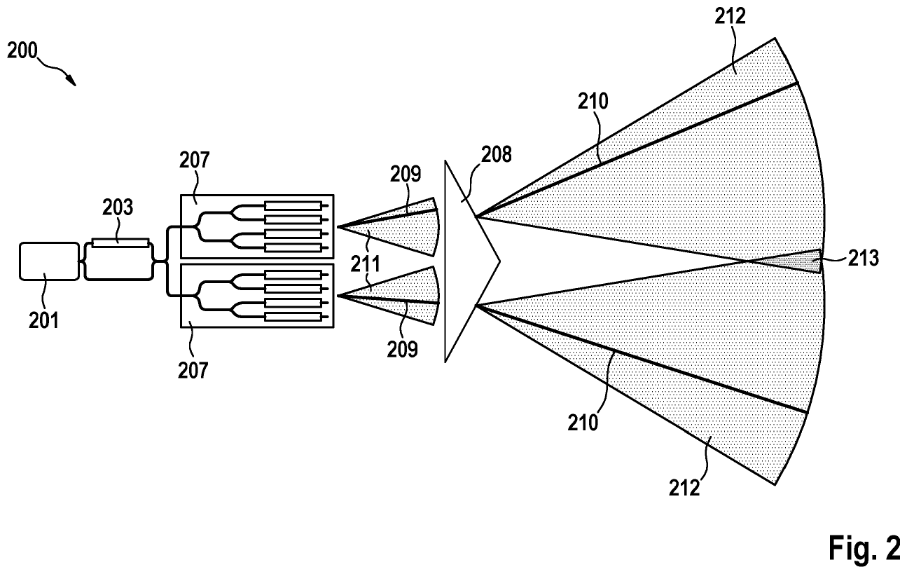

FIG. 2 shows a device for deflecting laser beams, including an area array that emits in the plane of the substrate surface, in accordance with an example embodiment of the present invention.

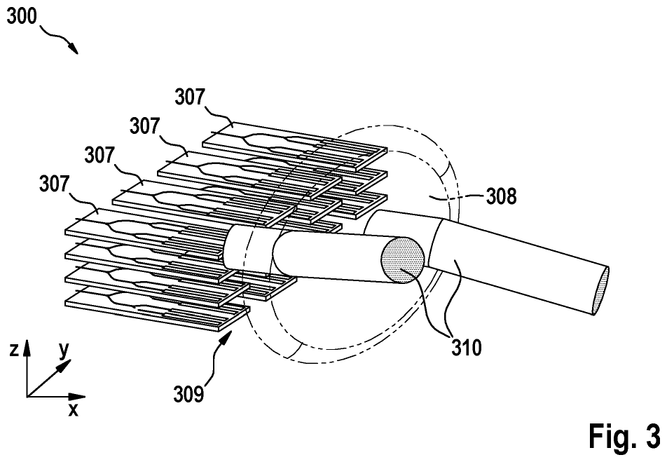

FIG. 3 shows a device for deflecting laser beams, including multiple area arrays that emit in the plane of the substrate surface and are situated one above the other, in accordance with an example embodiment of the present invention.

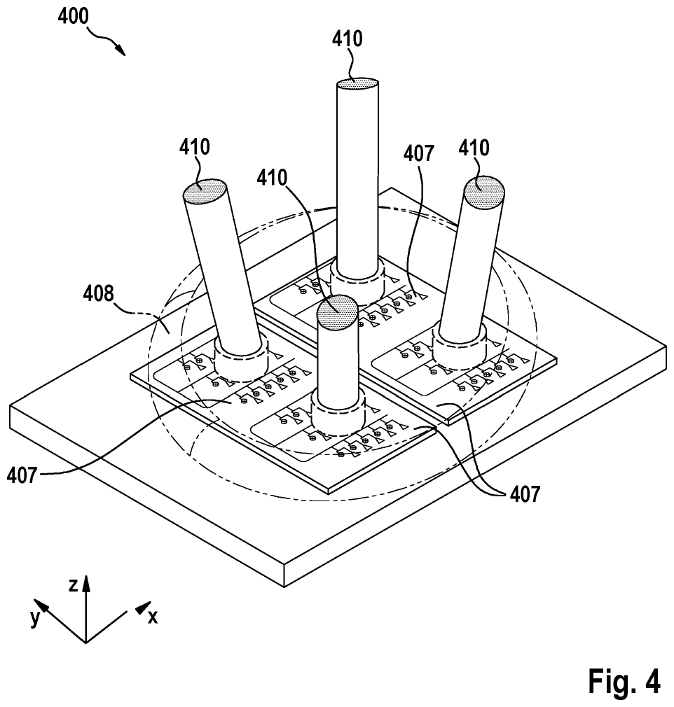

FIG. 4 shows a device for deflecting laser beams, including multiple area arrays that emit perpendicularly with respect to the plane of the substrate surface, in accordance with an example embodiment of the present invention.

### DETAILED DESCRIPTION OF EXAMPLE EMBODIMENTS

FIG. 1 shows a schematic layout of device 100 for deflecting laser beams. Device 100 includes a coherent light source 101, an integrated optical circuit 107, and a deflection means 108. Integrated optical circuit 107 includes at least one coupler 102, which may be an evanescent coupler, a multimode waveguide, or a light splitter, for example. Integrated optical circuit 107 includes multiple waveguides 104 and multiple phase shifters 105 which set or control the phase of the light. Phase shifters 105 are, for example, thermally-, electrooptically-, magnetooptically-, or MEMS-based, or are based on nonlinear optical effects. Integrated optical circuit 107 also includes multiple emission means 105 that emit the laser beams into the surroundings. Emission means 105 are grating couplers or mirrors, for example, when the first direction or the propagation direction of the laser beams extends in parallel to the third main direction of extension. When the first direction or the propagation direction of the laser beams extends in parallel to the first main direction of extension or the second main direction of extension, i.e., in the plane of the substrate surface, emission means 105 is an edge coupler, for example. In the case of using an edge coupler, the efficiency of emission means 105 may be increased when inverse tapers are additionally provided downstream. The inverse tapers are necessary for designing the optical directional characteristic in such a way that the optical power is maximized in the predefined or desired deflection range. Deflection means 108 includes an optical element that is situated in the beam path of the laser beam in the propagation direction. This optical element deflects the laser beam of each integrated optical circuit 107 in a direction, i.e., the second direction, which is different from the first direction. In other words, the optical element changes the propagation direction of each laser beam. The optical element is designed in such a way that adjacent integrated optical circuits cover slightly overlapping or adjoining areas, so that no unscannable areas arise. This is ensured in that the scanning area of an individual optical circuit overlaps with the scanning area of the adjacent optical circuit. Deflection means 108 is a lens, a microlens array, or a multistage prism, for example. In other words, the light beam or laser beam that is emitted by the coherent light source is guided to integrated optical circuit 107 via coupler 102, deflection means 108 being situated at the output of the integrated optical circuit, in the beam path of the first direction and spaced apart from the substrate of integrated optical circuit 107. Integrated optical circuits 107 optionally include optical switches that are situated between coupler 102 and waveguides 104. Alternatively, each integrated optical circuit 107 may include its own light source 101.

FIG. 2 shows a device 200 for deflecting laser beams, including an area array that includes two integrated optical circuits 207 by way of example. The area array emits at one end of the particular substrate, in the plane of the substrate surface. Device 200 includes a coherent light source 201, optical switches 203, and a deflection means 208 in the form of a prism. In addition, FIG. 2 shows beam path 209 of the laser light at the output of integrated optical circuits 207, scanning areas 211 of the phased arrays in front of deflection unit 208 and deflected laser beams 210 after the deflection by deflection means 208, as well as scanning areas 212 of the phased arrays behind deflection unit 208. An overlap 213 of scanning areas 212 is also shown.

FIG. 3 shows a device 300 including multiple integrated optical circuits 307 that are situated in such a way that the radiation plane or the emission plane is spanned by second main direction of extension y and third main direction of extension z. Each integrated optical circuit 307 emits laser beams along the first direction, which in the present example is the same as first main direction of extension x. In addition, each optical circuit 307 is capable of dynamically, i.e., variably, deflecting the optical beam in a scanning area along second main direction of extension y. Deflection means 308 then transforms this deflection range to a new deflection range. FIG. 3 shows by way of example beam path 309 of the laser light at the output of integrated optical circuits 307 and deflected laser beams 310 after the deflection by deflection means 308. Deflection means 308 is an elliptical lens in the present example.

FIG. 4 shows multiple integrated optical circuits 407 that are situated in such a way that first main direction of extension x and second main direction of extension y span the radiation plane or the emission plane for the laser light. In other words, integrated optical circuits 407 are situated on a shared carrier substrate as a two-dimensional area array. The laser beams are emitted in the direction of third main direction of extension z. Deflection means 408 is situated at a distance above the shared carrier substrate. By way of example, FIG. 4 shows beam path of the laser light at the output of integrated optical circuits 407 and deflected laser beams 410 after the deflection by deflection means 408. Deflection means 408 is an elliptical lens in the present example.

Device 100, 200, 300, and 400 for deflecting laser beams is used, for example, in LIDAR systems, preferably for vehicles, in pico projectors, or in head-up displays.

1-9. (canceled)

10. A device for deflecting laser beams, comprising:
at least one light source configured for generating laser beams; and
at least one integrated optical circuit, the integrated optical circuit being situated on a substrate, the substrate having a first main direction of extension, a second main direction of extension, and a third main direction of extension, and the first main direction of extension and the second main direction of extension spanning a plane of the substrate surface, and the third main direction of extension being orthogonal to the plane of the substrate surface, the integrated optical circuit including at least one waveguide and at least one emission element, the emission element functioning as an output of the integrated optical circuit and emitting the laser beams along a first direction; and
a deflection element spaced apart from the substrate along the first main direction of extension or along the second main direction of extension or along the third main direction of extension, the deflection element deflecting the laser beams along a second direction, the second direction being different from the first direction.

11. The device as recited in claim 10, wherein the integrated optical circuit includes at least one phase shifter and at least two of the at least one emission elements.

12. The device as recited in claim 10, wherein the at least one optical circuit includes multiple integrated optical circuits which are situated on a shared carrier substrate.

13. The device as recited in claim 10, wherein the first direction is the third main direction of extension.

14. The device as recited in claim 10, wherein the first direction is the first main direction of extension or the second main direction of extension.

15. The device as recited in claim 10, wherein multiple carrier substrates including multiple of the at least one optical circuit are situated one above the other, spaced apart along the third main direction of extension.

16. The device as recited in claim 10, wherein the deflection element includes at least one lens.

17. The device as recited in claim 10, wherein the deflection element includes a microlens array.

18. The device as recited in claim 10, wherein the deflection element includes a prism.

19. The device as recited in claim 18, wherein the prism is a multistage prism.
